(19) United States
(12) Patent Application Publication
(10) Pub. No.: US 2014/0173856 A1
(43) Pub. Date: Jun. 26, 2014

(54) CLAMP ASSEMBLY AND A CLAMP ELEMENT FOR CLAMPING BOUYANCY ELEMENTS TO PIPELINE RISERS

(71) Applicants: James Francis William Kingston, Henderson (AU); Christopher David Howard, Henderson (AU)

(72) Inventors: James Francis William Kingston, Henderson (AU); Christopher David Howard, Henderson (AU)

(73) Assignee: MATRIX COMPOSITES & ENGINEERING LTD, Henderson, WA (AU)

(21) Appl. No.: 14/122,267

(22) PCT Filed: Nov. 25, 2011
(86) PCT No.: PCT/AU2011/001523

§ 371 Date: Feb. 10, 2014

(30) Foreign Application Priority Data
May 26, 2011 (AU) 2011902051

(51) Int. Cl. E21B 17/01; F16L 1/20

(52) U.S. Cl. CPC E21B 17/012; F16L 1/20
USPC 24/285

(57) ABSTRACT

A clamp element is provided that has a T-shaped body with laterally extending portions on either side of a radially projecting tang. A plurality of the clamp elements are joined together in an array to form a clamp assembly with the tangs facing outwardly. Straps having looped ends are disposed around the array. The looped ends of the straps are engaged with respective cross bar members. Adjacent cross bar members are connected together by means of a threaded bar which is arranged to tighten the straps around the array of clamp elements.

### FIELD OF THE INVENTION

The present invention relates to a clamp and a clamp element.

In operations involving subsea gas and oil production, there is provided a riser or an umbilical which is used to convey product, power and communications between seabed assets and the surface. In order to offset the weight of the assembly, clamps are attached to the riser or umbilical at selected locations and buoyancy jackets are wrapped around the clamps.

### SUMMARY OF THE INVENTION

It has now been discovered that clamps can be formed of a plurality of relatively small elements which are, arranged to be mounted around an outer surface of a riser or umbilical.

In accordance with one aspect of the present invention there is provided a clamp element characterized by comprising a body having and outward facing portion with a projection arranged to engage with a buoyancy element, an inward facing portion and a pair of opposed laterally extending portions arranged to be attached to an umbilical or riser.

The clamp element of the present invention may conveniently be manufactured from thermoplastic material which is injection moulded to produce the clamp element.

The clamp element of the present invention is envisaged to be assembled into an array of similar clamp elements to form a clamp having a central aperture and arranged to be mounted about a riser or umbilical.

In accordance with a further aspect of the present invention there is provided a clamp assembly comprising a plurality of clamp elements characterized by the clamp elements each comprising a body having an outward facing portion with a projection arranged to engage with a buoyancy element, an inward facing portion, and a pair of opposed laterally extending portions arranged to be attached to an umbilical or riser, the clamp elements being joined together laterally with the projections facing outwardly, such that, in use, the inward facing portions are arranged to be mounted adjacent a riser or umbilical and the projections of the outward facing portions are arranged to be mounted to a buoyancy element.

### DESCRIPTION OF THE DRAWINGS

The present invention will now be described, by way of example, with reference to the accompanying drawings, in which:

FIG. 1 is a perspective view of a clamp element in accordance with the present invention;

FIG. 2 is a side elevation of the clamp element of FIG. 1;

FIG. 3 is a plan view of the clamp element of FIG. 1;

FIG. 4 is a plan view of a clamp assembly comprising a plurality of clamping elements in accordance with the present invention joined together;

FIG. 5 is a perspective view of the clamp assembly of FIG. 4;

FIG. 6 is a side elevation of the clamp assembly of FIG. 4;

FIG. 7 is a sectional view taken along the line A-A of FIG. 6; and

FIG. 8 is a second sectional view, again taken along the line A-A of FIG. 6, illustrating a proposed tensioning fastener.

### DETAILED DESCRIPTION OF THE DRAWINGS

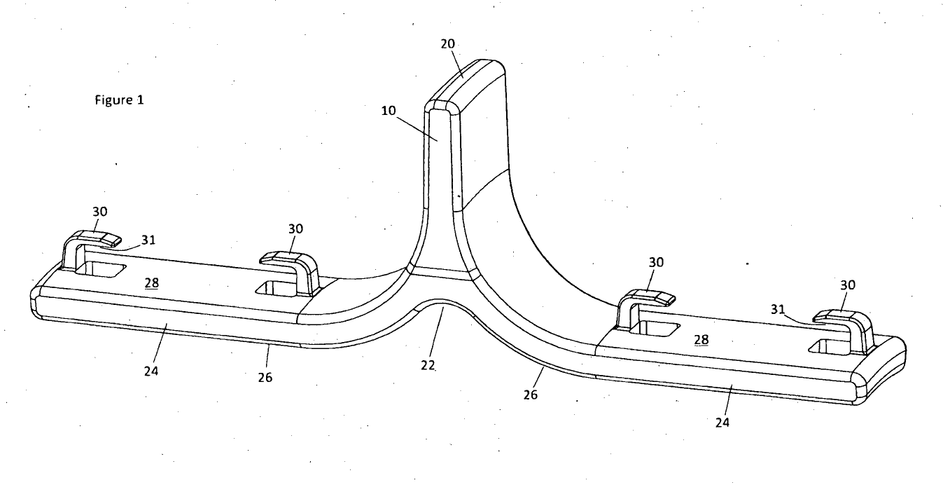

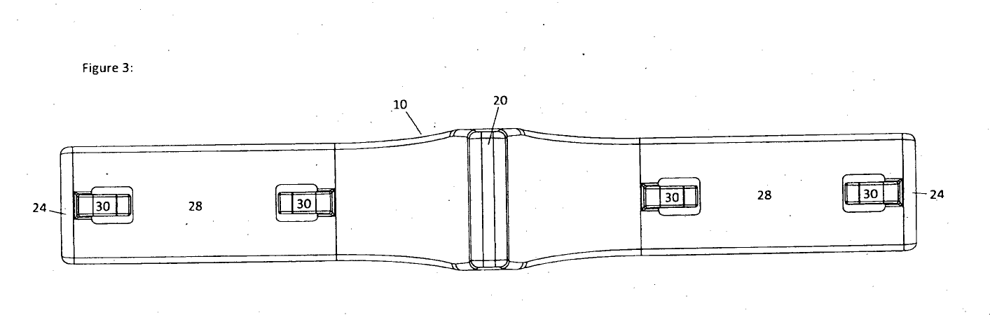

In FIGS. 1 to 3 of the accompanying drawings there is shown a clamp element 10 in accordance with the present invention comprising a generally T-shaped body having opposed laterally extending portions 24 on either side of a radially projecting tang 20. Furthermore, the laterally extending portions 24 each comprise an outer face 28 and an inner face 26. The radially projecting tang 20 is disposed between the outer faces 28.

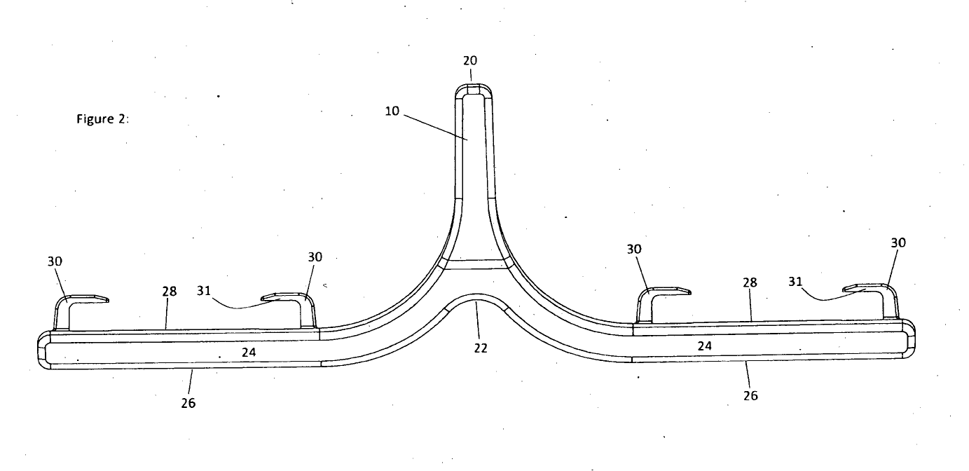

Opposite to the tang 20, between the inner faces 26, is a cavity 22. Finally, each outer surface 28 is provided with a pair of opposed L-shaped brackets 30. As can best be seen in FIG. 2 the L-shaped brackets 30 on each face 28 face one another with a horizontal portion 31 facing the other bracket 30 on each face 28.

A plurality of the clamp elements 10 are joined together as will be described in an array to form a clamp assembly. In that context the array of clamp elements 10 is mounted about a riser or umbilical with faces 26 and cavities 22 adjacent to the riser or umbilical. Further, the radially projecting tangs 20 engage with buoyancy elements used to offset the weight of the assembly in which the clamp elements 10 are used.

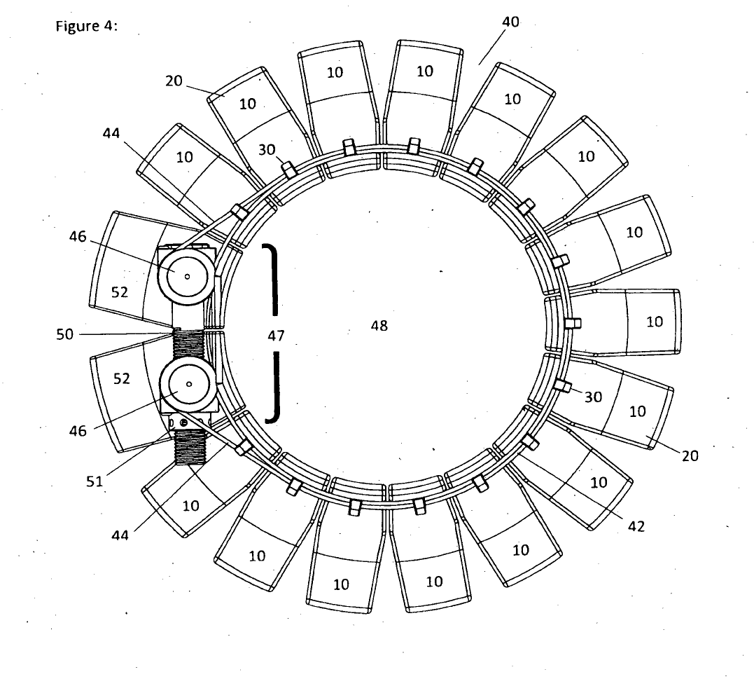

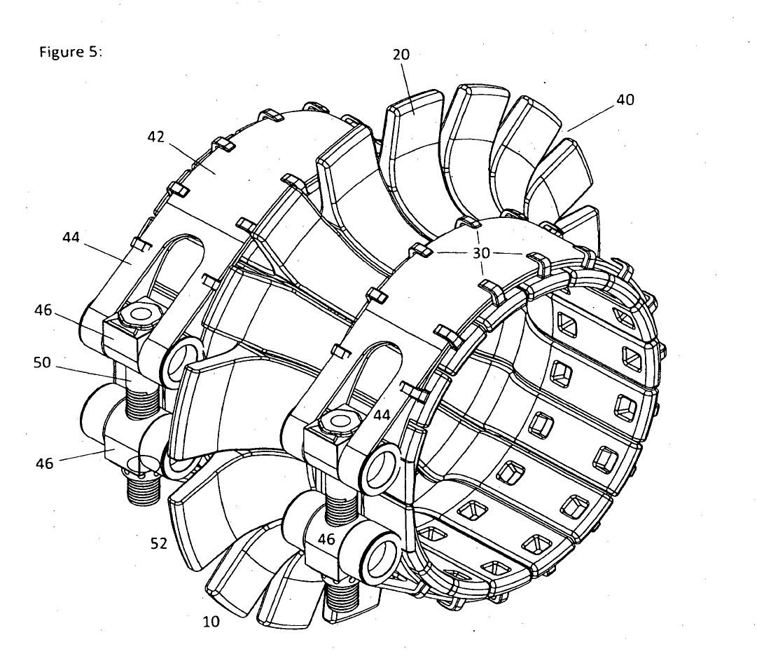

As shown in FIGS. 4 to 8, a plurality of the clamp elements 10 are arranged in a preferably circular, array to form a clamp assembly 40. This is done by placing the elements 10 in an array with the radially projecting tangs 20 and brackets 30 facing outwardly. Flexible straps 42 are inserted between aligned pairs of brackets 30 on either side of the radially projecting tangs 20 as best seen in FIG. 5. As shown, the straps 42 each extend across the array of clamp elements 10 in double thickness. Further, the flexible straps 42 each have looped ends 44.

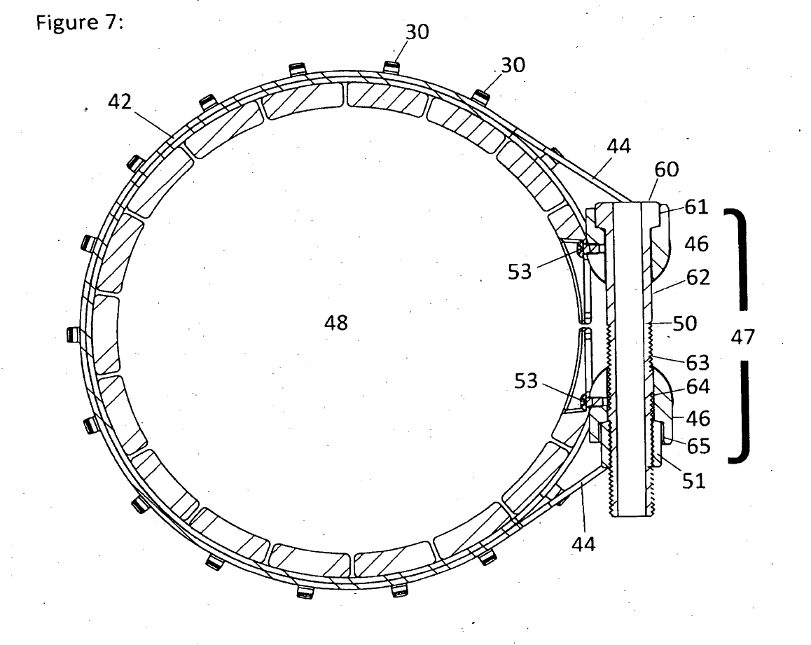

The looped ends 44 are placed around respective cross-bar members 46 of a retaining means 47 shown generally in FIGS. 4 and 7. As can be seen in FIGS. 4 and 7, cross-bar members 46 on each side of the clamp assembly 40 are interconnected by a hollow, removable threaded bar 50 and round nut 51 to form the retaining means 47. Thus, the straps 42 and retaining means 47 encompass the laterally extending portions 24 of the clamp elements 10, within lateral boundaries set by opposed brackets 30, thereby forming a continuous tensile load path.

The threaded bar 50 has a head 60 which has a polygonal, such as hexagonal lateral, shape in plan view. As shown in FIG. 7 the head 60 is engaged with a recess 61 in a cross-bar member 46. The recess 61 has a lateral shape corresponding to that of the head 60.

As shown in FIG. 7 an upper portion 62 of the bar 50 is plain whilst a lower portion 63 is threaded. The lower portion 63 passes through an aperture 64 in a further cross-bar member 46. The further cross-bar member 46 has an aperture 65 which has a lateral shape that can accommodate that of the round nut 51.

Further as can best be seen in FIGS. 4 and 7, the arrangement is such that the array defines a generally circular central aperture 48.

In use, the plurality of clamp elements 10 are assembled together by means of the straps 42. At each end of the assembly there is provided a cross-bar member 46 having engaged therewith a loop 44 of a strap 42. Initiator elements 52 are a modified version of clamp element 10, where the outer face 28 incorporates a flat zone upon which a cross bar 46 may slide. Once engaged with a loop 44 of the strap 42, the cross-bar member 46 is pinned onto the flat zone of the initiator element 52 using a fastener 53, thereby providing some degree of stability to the open assembly.

With the assembly open, the clamp assembly 40 can be wrapped around a riser or an umbilical so that pairs of cross-bar members 46 with connections to a strap 42 in looped ends 44 are brought together.

Once wrapped around the riser or umbilical and positioned correctly the clamp assembly 40 is closed by engaging a hollow threaded bar 50 with a pair of adjacent cross-bar members 46 described above and as shown in FIG. 7. The round nut 51, comprises a hollow cylinder cut with an internal thread matching that found on the threaded bar 50.

The round nut 51 may then be wound onto the threaded bar 50, closing the circumferential load path and completing the retaining means 47.

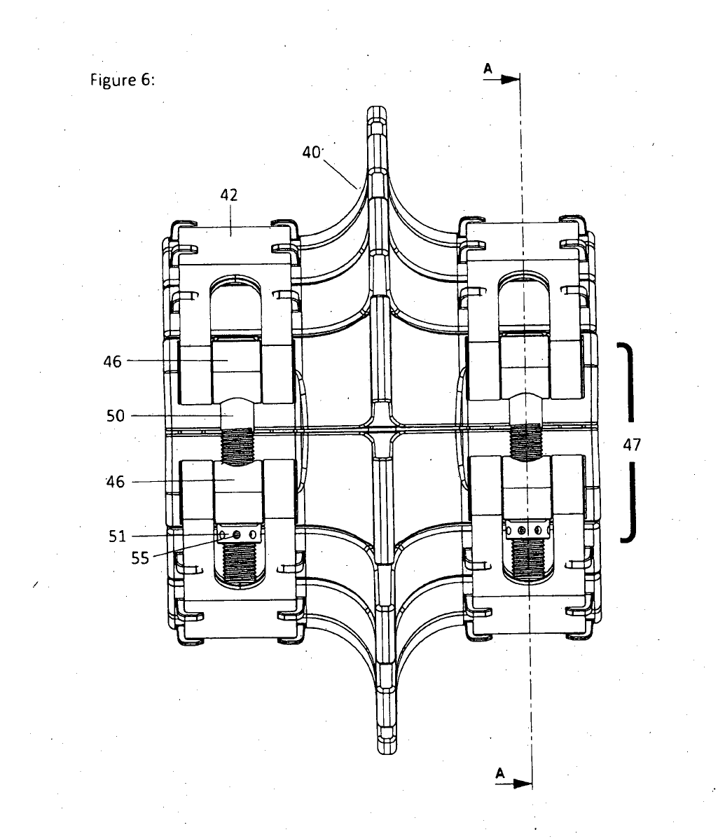

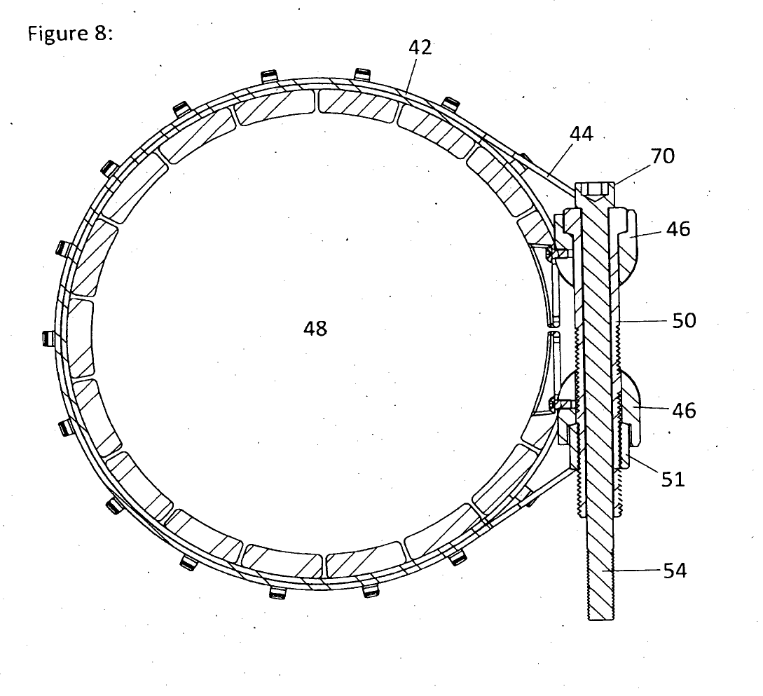

As shown in FIG. 8, a second, smaller threaded fastener 54 may then be passed through the hollow aperture in the threaded bar 50 such that a length of thread projects beyond retaining means 47 when a head 70 of the fastener 54 abuts the head 60 of the hollow threaded bar 50. Standard hydraulic tensioning equipment may then engaged threaded bar 50 and abutted upon a cross-bar member 46 reducing the required length of the threaded bar 50. The fastener 54 is then tensioned so as to tension the strap 42 and pull the assembly 40 onto the riser or umbilical to a desired extent so that the assembly can be used for its intended purpose. Once the strap 42 is properly tensioned, the round nut 51 may then be wound down to abut the adjacent cross-bar member 46 by means of tommy bar holes 55 shown in FIG. 6, bored into the flank of the round nut 51 at regular intervals.

Alternatively, the straps 42 may be tensioned by other mechanical or hydraulic means and the resulting slack in the retaining assembly 47 removed by rotating the round nut 51 as best seen in FIG. 6.

Modifications and variations as would be apparent to a skilled addressee are deemed to be within the scope of the present invention.

1-18. (canceled)

19. A clamp assembly comprising:
a plurality of clamp elements arranged in an array of clamp elements, each clamp element of the plurality of clamp elements having a body comprising:
an outward facing portion with a projection arranged to engage with a buoyancy element,
an inward facing portion, and
opposed laterally extending portions having outer faces and being arranged to be attached to an umbilical or riser,
the plurality of clamp elements being joined together laterally with each projection facing outwardly, such that, in use, the inward facing portions are arranged to be mounted adjacent to a riser or umbilical and each projection of the outward facing portions are arranged to be mounted to the buoyancy element.

20. The clamp assembly according to claim 19, wherein each clamp element has a cavity opposite to the projection thereof, each cavity facing inwardly.

21. The clamp assembly according to claim 19, further comprising flexible straps mounted to outer faces of the opposed laterally extending portions, the flexible straps extending around the array of clamp elements so as to interconnect the plurality of clamp elements.

22. The clamp assembly according to claim 19, wherein the array of clamp elements is arranged to define a circular aperture.

23. The clamp assembly according to claim 21, wherein the flexible straps are engaged with the plurality of clamp elements by brackets mounted on front faces of the opposed laterally extending portions.

24. The clamp assembly according to claim 21, wherein the flexible straps extend around the array of clamp elements about the opposed laterally extending portions on opposite sides of each projection of the outward facing portions.

25. The clamp assembly according to claim 21, wherein the flexible straps have a double thickness configuration with looped ends, and wherein the flexible straps engage the looped ends.

26. The clamp assembly according to claim 23, wherein the brackets comprise pairs of opposed L-shaped brackets and the flexible straps extend between the pairs of opposed L-shaped brackets.

27. The clamp assembly according to claim 23, wherein the flexible straps extend around the array of clamp elements about the opposed laterally extending portions on opposite sides of each projection of the outward facing portions.

28. The clamp assembly according to claim 23, wherein the flexible straps have a double thickness configuration with looped ends, and wherein the flexible straps engage the looped ends.

29. The clamp assembly according to claim 26, wherein the flexible straps extend around the array of clamp elements about the opposed laterally extending portions on opposite sides of each projection of the outward facing portions.

30. The clamp assembly according to claim 26, wherein the flexible straps have a double thickness configuration with looped ends, and wherein the flexible straps engage the looped ends.

31. The clamp assembly according to claim 24, wherein the flexible straps have a double thickness configuration with looped ends, and wherein the flexible straps engage the looped ends.

32. The clamp assembly according to claim 25, further comprising a tensioner to tension the flexible straps so as to draw the plurality of clamp elements together.

33. The clamp assembly according to claim 32, wherein the tensioner comprises cross-bar members engaged with respective looped ends of the flexible straps so that varying a distance between the looped ends of the flexible straps adjusts the tension of the flexible straps.

34. The clamp assembly according to claim 33, wherein each cross-bar member further comprises an aperture and a threaded bolt for engaging apertures of respective cross-bar members; wherein each cross bar member is engaged with respective looped ends of the straps, and wherein the threaded bolt is arranged to draw each the cross-bar member together as required.

35. The clamp assembly according to claim 34, wherein the threaded bolt is engaged with a nut, and a head of the threaded bolt is engaged in a first cross-bar member while the nut is arranged to be engaged with a second cross-bar member.

36. The clamp assembly according to claim 34, wherein the threaded bolt is hollow and a threaded fastener is mounted within the threaded bolt such that a head of the threaded fastener can engage the threaded bolt with a threaded portion of the fastener extending beyond the cross-bar member so that tensioning equipment may be engaged with the fastener to apply tension to the flexible straps.

37. The clamp assembly according to claim 35, wherein the threaded bolt is hollow and a threaded fastener is mounted within the threaded bolt such that a head of the fastener can engage the threaded bolt with a threaded portion of the fastener extending beyond a cross-bar member so that tensioning equipment may be engaged with the fastener to apply tension to the straps.
